(19) United States
(12) Patent Application Publication
(10) Pub. No.: US 2004/0205539 A1
(43) Pub. Date: Oct. 14, 2004

(54) Method and apparatus for iterative merging of documents

(76) Inventors: Mingchi Stephen Mak, Belmont, CA (US); Akhil K. Arora, San Jose, CA (US); Herbert T. Ong, Cupertino, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 09/949,127

(22) Filed: Sep. 7, 2001

(51) Int. Cl. G06F 17/24; G06F 17/21

(52) U.S. Cl. 715/511; 715/530

(57) ABSTRACT

The present invention is a technique to iteratively merge two or more documents. The documents represent different versions of an original document. After obtaining the documents, the differences between the versions are determined. In one embodiment, the present invention uses a Longest Common Subsequence algorithm to determine modifications necessary to merge the changes made to one document into the other document. The documents are analyzed at various levels of analysis. Thus, segments of a word processing document are analyzed for differences in paragraphs while other segments are analyzed for differences in words. In one embodiment of the present invention, a conflict resolution block resolves conflicts arising from a merge process involving three or more documents. The modifications are merged back into a single document.

### BACKGROUND OF THE INVENTION

1. Field of the Invention

The present invention relates to the field of computer software, and in particular to a method and apparatus for the iterative merging of documents.

Sun, Sun Microsystems, the Sun logo, Solaris and Java are trademarks or registered trademarks of Sun Microsystems, Inc. in the United States and other countries.

2. Background Art

Personal Digital Assistants (PDAs) are small hand-held computers that perform a wide variety of tasks and functions. PDAs are versatile devices that users carry and operate almost anywhere. PDAs possess a smaller amount of memory and storage space than is typically found in desktop general purpose computer systems. Thus, word processing documents may require more memory than is available on a PDA. This problem can be better understood with a review of PDAs.

PDAs

A PDA is a small computer-like device, usually no larger than the palm of a human hand, which typically has a base housing with an input mechanism mounted on its topside, and a miniature display screen for output. FIG. 1 is an illustration of one embodiment of a personal digital assistant. The PDA (100) shown in FIG. 1 is manufactured by 3Com and is called a Palm™. However, it will be apparent to one with ordinary skill in the art that the present invention can be used with any suitable word processing software application on any suitable small device computer system. The PDA has a base housing (160) with input mechanisms mounted on its topside, and a miniature display screen (110) for output. The base housing of the PDA contains a small microprocessor, data storage and memory areas, a storage battery, and other various miniature electronic components. The electronic components and other features vary depending on the model, make, and manufacturer of the PDA. The PDA is activated and de-activated by accessing the power button (150).

PDA output may take the form of either graphic and/or textual images presented to users on the miniature display screen, or may be presented to users in the form of sound. Additionally, some PDAs can package information for output through cable or wireless networks. Thus, data is transmitted to a general purpose computer. Likewise, data transfers from general purpose computers to PDAs via the same mechanism.

The input mechanism may be, for example, a miniature keyboard (not shown). Alternatively, the miniature display screen may act as both an input and output mechanism. When used as an input mechanism, the user inputs the data via a pen-like stylus or other writing implement (not shown) directly on the display screen. This could take the form of handwriting, or highlighting certain specific areas on the display screen such as buttons, icons, or captions. With reference to FIG. 1, the bottom portion (120) of the display screen is where the user would input using the pen-like stylus. Additional mechanisms for user input include a scroll button (130) and four application buttons (140).

PDAs also contain an operating system, which is different from ones available for a general purpose desktop computer. PDAs also contain pre-loaded programs, such as word processing, spreadsheet, e-mail, and other related applications. The increasing popularity of PDAs stem from their relatively low cost and extreme portability compared to, for example, much larger desktop general purpose desktop or laptop computers. Their popularity also stems from the fact that they can communicate with most popular desktop applications like spreadsheet programs, word processing programs and e-mail. Thus, transfer of data between PDAs and general purpose desktop computers is convenient and useful. Many users find that for simple computing tasks during trips and other periods of being away from their larger computers, PDAs suffice, and the computing power of even a compact notebook computer is not necessary.

PDA Data Transfers

A conventional means of transferring data is by way of a conduit. FIG. 2 illustrates one mechanism by which a user transfers data from a desktop CPU (200) to a PDA (210), or vice versa. The desktop CPU couples to the PDA carriage (220) via a connecting line (230).

The connecting line provides a two-way data communication coupling via a desktop CPU to a PDA. Although, the connecting line represents a cable connection, it will be apparent to one skilled in the art, that the present invention may be practiced with numerous types of connections. For example, if the connecting line is an integrated services digital network (ISDN) card or a modem, the connecting line provides a data communication connection to the corresponding type of telephone line. Additionally, wireless links are available to the present invention. In any such implementation, the connecting line sends and receives electrical, electromagnetic or optical signals, which carry digital data streams representing various types of information. In some implementations, computer software, termed “conduits,” control the transmission of data streams through the connecting line.

In operation, a user would insert the PDA into the carriage in the direction generally indicated by the black arrow (240). Thereafter, data is passed bi-directionally across the conduit to achieve the result of transferring data between a PDA and a desktop general purpose computer.

PDA Memory and Storage

Due to size and cost limitations, PDAs have less memory and storage space than desktop general purpose computers. Thus, conservation of memory and storage space is a major concern when designing programs and documents for use on PDAs. If programs are too large, they may consume all the memory or storage space resources of a PDA. If a memory intensive program consumes all the memory of a PDA when running, a user is restricted from running any other program while the memory intensive program runs. Additionally, if a program consumes all the storage space of a PDA, the user is restricted from storing any other data on the PDA. Thus, programs that consume heavy resources limit the versatility of PDAs and make them less useful to consumers.

Documents associated with programs present an additional drain on memory and storage space resources. If the documents are large, they might consume enough memory and storage space to limit the versatility of PDAs. Additionally, documents are frequently transmitted between PDAs and desktop general purpose computers, and such transmissions sometimes occur over expensive wireless networks. Thus, larger documents increase the cost in time and money for transmissions. Thus, it is important to represent the information in a document compactly since compact documents consume less memory and storage space.

Conversion of Formats

One method of addressing the problem of document size on PDAs is to convert standard documents (e.g., a Microsoft Word document or WordPerfect document) to a more compact form, such as rich text format (RTF) or plain text. However, the conversion of a standard word processing document to RTF or plain text results in significant loss of stylistic information. Thus, if the document is transmitted to a PDA and then transmitted back to a conventional computer, it loses its stylistic attributes such as bullets, tables and fancy fonts.

Merging Documents

One way to retain stylistic attributes when moving a document from a PDA to a general purpose computer is to merge the PDA version with a previous version that existed on the computer and had stylistic attributes. A problem encountered in this technique is that the comparison of the documents is complicated by the limited amount of formatting information allowed in a PDA document, as compared to a document generated by a word processor program on a computer. A common method of comparing two documents is the use of an algorithm that finds the difference between two documents. An example of such an algorithm is Longest Common Subsequence (LCS) algorithm.

Longest Common Subsequence

A subsequence may be defined in this way: given a short string (pattern) and a long string (text), the pattern is a subsequence of the text if the set of characters comprising the pattern is contained, but possibly separated, in the text. For example, the pattern, “N E T”, is a subsequence of the text, “I N V E N T I O N”, at the second, fourth, and sixth positions in the text.

The longest common subsequence (LCS) is the longest subsequence that appears in both pattern and text. In the “I N V E N T I O N” example, “N E T” is both a subsequence of “I N V E N T I O N” and the LCS of both sequences. Suppose, however, that the text is “Y E T I”. In this case, “E T I” is the LCS of both pattern and text.

### SUMMARY OF THE INVENTION

Embodiments of the present invention disclose a technique to iteratively merge two or more documents. In one embodiment of the present invention, a first and a second document is obtained. The first document is, for instance, a word processing document that was transferred to a PDA and lost its stylistic data and a second previous version of the word processing document on a typical computer that had the stylistic information. Next, the differences between the documents are determined. In one embodiment, the algorithm uses a Longest Common Subsequence algorithm to determine the locations and type of modifications necessary to obtain the differences between one document and another.

To iteratively merge the documents, they are analyzed at varying levels of scope. For example, the analysis of a word processing document comprises the blocks of determining the differences at a paragraph level, subsequently at a word level and optionally at the character level. For a spreadsheet document, differences are determined at a worksheet level, and then at a row and cell level. Last, the modifications are merged back into a single document.

In another embodiment of the present invention, the modifications to two or more document versions are merged into an original document, which is usually a server side document with extra style information. In this embodiment, one of the documents is selected to represent the original document. This document is compared to two or more document versions to determine the locations and type of modifications necessary to merge the changes of each document into the original document. The differences are then analyzed to resolve conflicts arising from the merge process. In one embodiment, a priority-based rule is applied to resolve any conflicts. In another embodiment of the present invention, a user-selected policy is applied to resolve any conflicts. After the conflict resolution block, the modifications are merged back into a single document.

### BRIEF DESCRIPTION OF THE DRAWINGS

These and other features, aspects and advantages of the present invention will become better understood with regard to the following description, appended claims and accompanying drawings where:

FIG. 1 is a block diagram of a personal data assistant used by an embodiment of the present invention.

FIG. 2 is a block diagram of a personal data assistant coupled to a desktop general purpose computer used by an embodiment of the present invention.

FIG. 3A is a block diagram of the architecture of the software in accordance with one embodiment of the present invention.

FIG. 3B is a block diagram of the architecture of the software in accordance with one embodiment of the present invention.

FIG. 4 is a block diagram of the methodology of one embodiment of the present invention.

FIG. 5A is a block diagram illustrating the flow of the iterative merge algorithm of one embodiment of the present invention.

FIG. 5B is a block diagram illustrating the flow of the iterative multidocument merge algorithm of one embodiment of the present invention.

FIG. 6A is a block diagram of the word processing document iterator hierarchy in accordance with one embodiment of the present invention.

FIG. 6B is a block diagram of the spreadsheet document iterator hierarchy in accordance with one embodiment of the present invention.

FIG. 7 is a flow diagram of the iterator algorithm in accordance with one embodiment of the present invention.

FIG. 8 is a flow diagram of the merge algorithm in accordance with one embodiment of the present invention.

FIG. 9 is a flow diagram of the iterative merge algorithm in accordance with one embodiment of the present invention.

FIG. 10 is an embodiment of a computer execution environment used by an embodiment of the present invention.

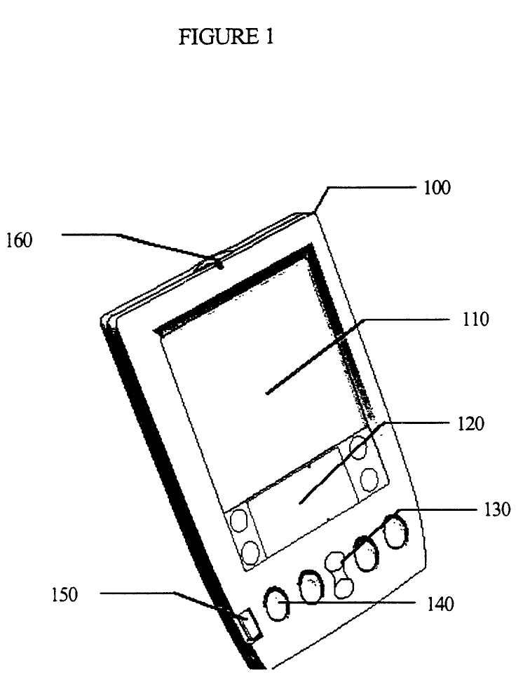

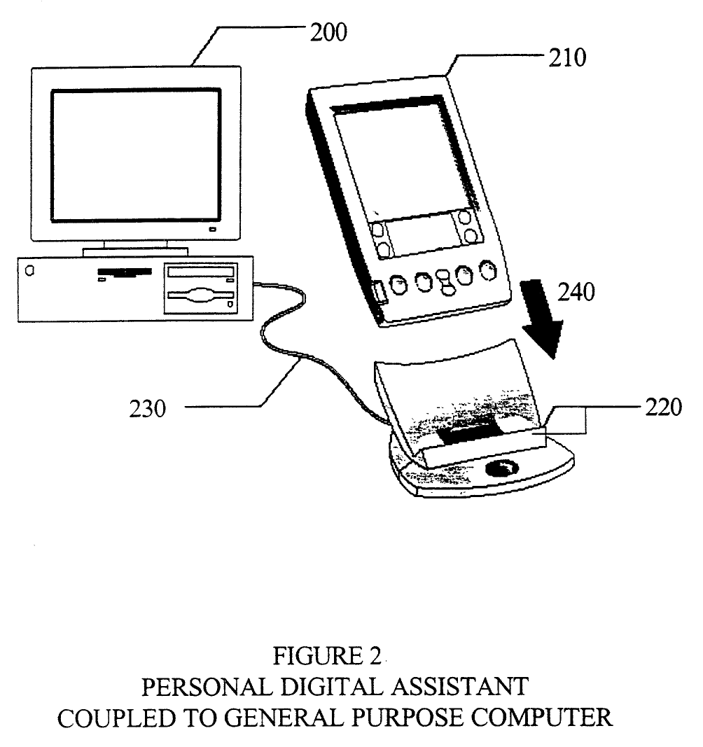

### DETAILED DESCRIPTION OF THE INVENTION

The invention is a method and apparatus for the iterative merging of two or more documents. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Software Architecture

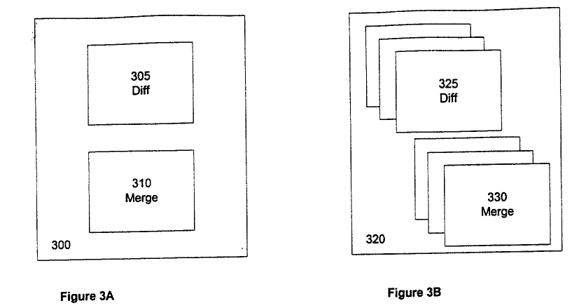

The structure of the software in one embodiment of the present invention is illustrated in FIG. 3A. Iterative document merger (IDM) 300 is comprised of difference (Diff) module 305 and merge module 310. Another embodiment of the present invention is illustrated in FIG. 3B. IDM 300 is comprised of a plurality of Diff modules 325 and a plurality of merge modules 330. In this embodiment, a separate Diff algorithm is selected for each type of analysis undertaken and correspondingly, a different Diff module is used. For example, different Diff algorithms are used for paragraph-level analysis and word-level analysis. Different merge modules are used for different document component types (or features). For example, merging paragraphs in a word processing document utilizes a different merge algorithm from merging tables in a worksheet document.

Iterative Merging Overview

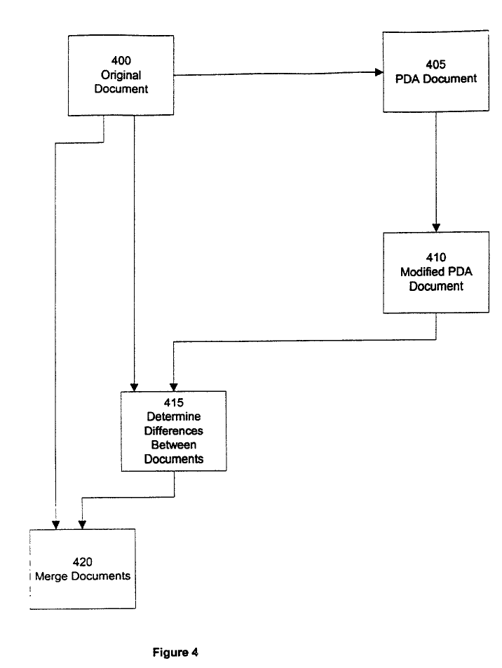

FIG. 4 is a block diagram illustrating an embodiment of the present invention. In blocks 400 and 405, two or more document versions are obtained, for example an original document version at block 400 and a PDA document version at block 405. In one embodiment, these documents are formatted in eXtensible Markup Language (XML) and the modified document version that has been modified on the PDA at block 410 may contain simplified XML formatting tags as compared to the original document version at block 400. This document is obtained from a PDA. There are two main blocks in the sequence—the diff block (415) and the merge block (420). In block 415, the differences between the documents are iteratively determined. The documents are merged in block 420. In the merge block, modifications to one or more document versions are incorporated into an original document version.

Merging of Documents

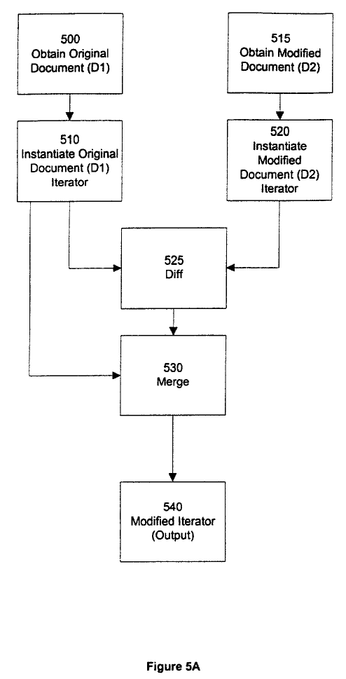

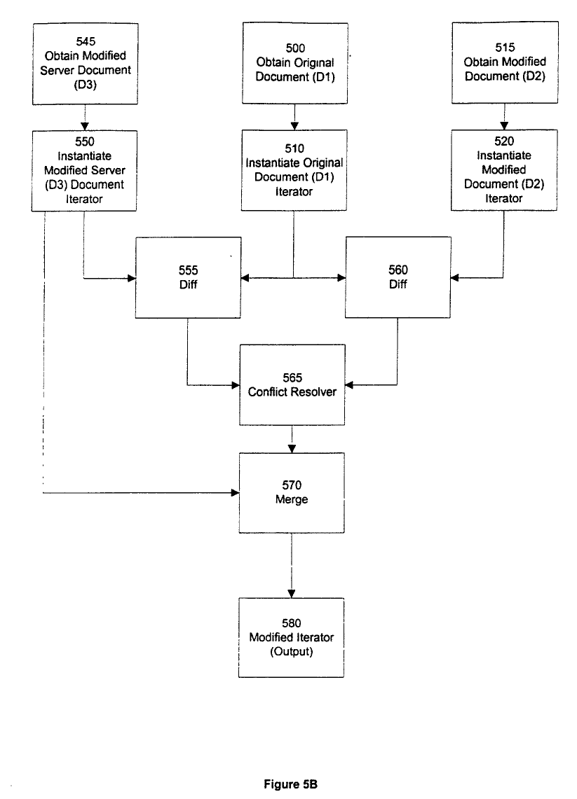

FIG. 5A is a flow diagram illustrating an embodiment of the present invention. In one embodiment of the present invention, all documents to be merged are formatted in XML. Accordingly, in block 500, the original XML document (D1) is obtained. In block 515, a modified version of D1 XML document (D2) is obtained. In one embodiment, D2 is obtained from a PDA. Thus, the XML tags of D2 comprise simplified formatting information as compared to D1 due to memory and storage space considerations.

In block 510, an iterator representing D1 is instantiated. The instantiation of the iterator is optional. Similarly, an optional iterator representing D2 is instantiated in block 520. An iterator hides the structure of the documents to be merged from the algorithm. It is an interface to enable the algorithm to interact on a sequence of objects, representing the components of a document, rather than the entire document. For example, a spreadsheet document may have objects such as tables, rows and cells. An iterator for a spreadsheet document allows the algorithm to operate iteratively on tables, rows and cells. These objects are inspected, inserted, removed, or replaced in any position of the sequence. Moreover, the objects are tested for differences through one or more Application Programming Interfaces (APIs).

In block 525, the differences between D1 and D2 are determined. In one embodiment of the invention, the Diff algorithm utilizes the LCS algorithm to determine the longest common subsequence of the two documents. The results of the Diff algorithm are stored in an array tabulating the differences between the documents. In block 530, the modified document changes are merged into the original document through a merger. A modified iterator is the output in block 540.

Three-Way Document Merge

FIG. 5B is a flow diagram illustrating an embodiment of the present invention in which a three-way merge is implemented. In this example the documents are in XML format, but XML is not required. In block 500 an original document (D1) is obtained. In block 515, a document (D2) representing a modified version of the original is obtained. For instance D2 might be a later version of D1 that a user transferred from a computer to a PDA, made changes to the text and wishes to incorporate those changes into the full, stylistic document on the computer. Thus the modified document contains minimal XML formatting tags. In block 545, a second modified document (D3) is obtained. In one embodiment of the present invention, this document is modified by a full-featured word processing or spreadsheet program such as StarWriter, Microsoft Word or WordPerfect.

In block 510, an iterator representing D1 is instantiated. Similarly, an iterator representing modified document D2 is instantiated in block 520. Last, an iterator representing modified document D3 is instantiated in block 550. In block 555, the differences between original document D1 and modified document D3 are determined. In block 560, the differences between original document D1 and modified document D2 are determined. Thus, in the current embodiment of the present invention, the individual changes for two document replicas are involved in the synchronization, so that after the synchronization is complete, the resulting data set is a combination of the data in both replicas. This merge process may cause conflicts which need to be resolved.

Thus, a conflict resolver is utilized in block 565 to deal with any problems associated with the three-document merge algorithm. In one embodiment of the present invention, a priority-based resolution rule is applied to any conflicts. The priority-based resolution rule chooses the document that was changed first. In another embodiment of the present invention, a user-selected policy is applied to any conflicts. The result of conflict resolution block 565 is a single array of document modifications.

In block 570, a document chosen to represent an original document is modified in accordance with the merge algorithm of one or more embodiments of the present invention. In one embodiment D1 is selected to be the original document for block 570. A modified iterator is the output in block 580.

Iterators

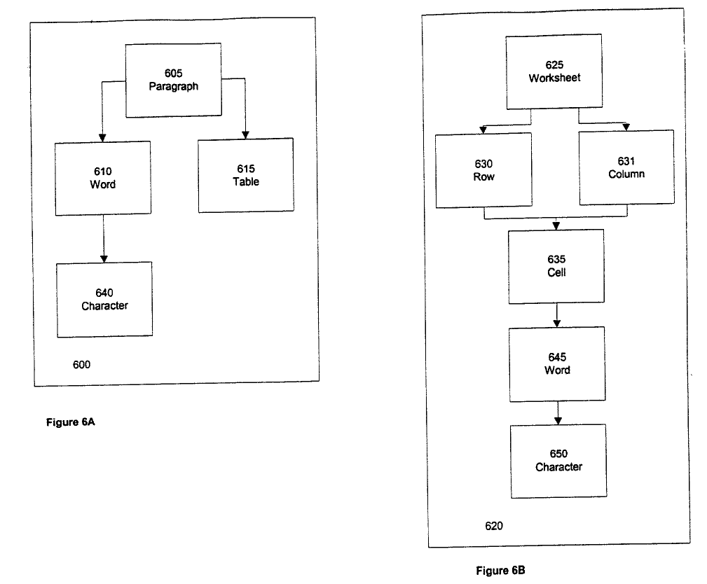

FIG. 6A is a block diagram illustrating an iterator hierarchy for word processing document 600 in accordance with one embodiment of the present invention. Paragraph iterator 605 is used by Diff module 305 in the determination of differences between one or more versions of document 600. If necessary, then either word iterator 610 or table iterator 615 are instantiated for a more detailed difference analysis. The decision as to whether word iterator 610 or table iterator 615 is instantiated is made based on the structure of the paragraph. If the current paragraph is a table or list, then table iterator 615 is instantiated. Otherwise, word iterator 610 is instantiated. If needed, a character iterator 640 is instantiated.

FIG. 6B is a block diagram illustrating the iterator hierarchy for worksheet document 620 in accordance with one embodiment of the present invention. Worksheet iterator 625 is used by Diff module 305 in the determination of differences between one or more versions of document 620. If a more detailed difference analysis is required, then row iterator 630 or column iterator 631 is instantiated for a row or column level analysis of the documents. Beyond the row or column level analysis, a cell iterator 635 is instantiated for a cell-level analysis. Beneath the cell iterator level is word iterator 645, then a character iterator 650.

Difference Algorithm

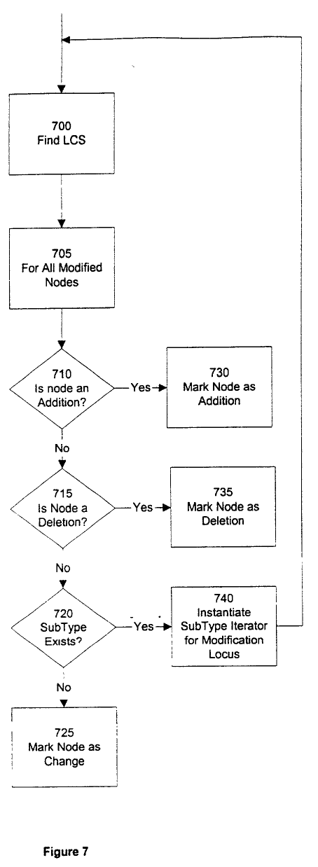

FIG. 7 is a flow chart illustrating the Difference (or Diff) Algorithm in accordance with one or more embodiments of the present invention. In block 700 the LCS of the current document iterator level (e.g. paragraph, word, character) is determined. The result of the LCS algorithm is the longest list of all unmodified nodes.

A modified node is a node in either sequence that is itself not in the LCS. In the word processing document example, a node could be a paragraph or a word or a character, depending on the level of analysis being performed. A node is modified in one of three ways: addition, deletion or change. Change is the alteration of a node located in both sequences. In block 705, the Difference algorithm iterates through all modified nodes. In 710, a determination is made as to whether the modified node is the result of an addition. Any new node between a common sequence is considered an addition. For example, an addition of <b2> to the original sequence of <a><b><c> results in a modified sequence of <a><b><b2><c>. If the result of determination block 710 is positive, then the modified node is marked as an addition in block 730.

If the result of determination block 710 is negative, then a determination is made in block 715 as to whether the modified node is the result of a deletion. Any node missing between a common sequence is considered a deletion. For example, a deletion of <b> from the original sequence of <a><b><c> results in a modified sequence of <a><c>. If the result of determination block 715 is positive, then the modified node is marked as a deletion in block 735.

If the result of determination block 720 is negative, then the modification must be a change. In the word processing document example, a character node does not have any sub-type. Thus a modification at a character node is marked as a change. A change is marked when a different node between a common sequence is encountered. For example, nodes <b1> and <b2> in original sequence <a><b1><b2><c> are changed so that the modified sequence is <a><b3><b4><c>. All nodes modified in a change operation together comprise a modification locus. At a more defined level (i.e., row vs. worksheet), the modification locus itself may comprise additions and deletions. In the example, the <b3> and <b4> modification locus may themselves comprise of additions and deletions that require further sub-type iteration to detect. Thus in block 720 a determination is needed to check whether a document subtype exists. If the result is negative, then in block 725 the node is marked as a change.

If the result of block 720 is positive, then in block 740 subtype iterators for the modification locus are instantiated. For example, a paragraph does have a sub-type (i.e. words). Thus a sub-type iterator, in this case, a word iterator is instantiated in block 740. The difference algorithm is then applied to the modification locus via the subtype iterators. The algorithm continues at the current level after the modification locus is fully analyzed.

Merge Algorithm

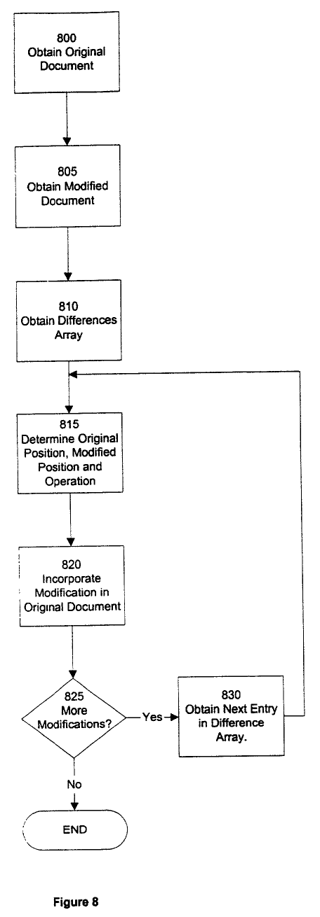

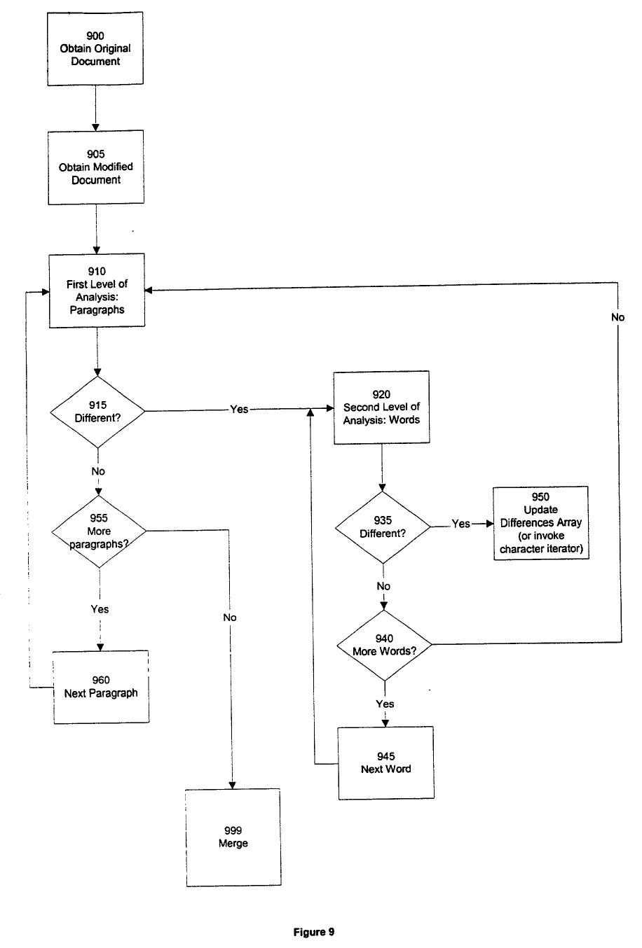

FIG. 8 illustrates the Merge Algorithm utilized in one or more embodiments of the present invention. In block 800, the original document is obtained. In block 805, a modified version of the original document is obtained. In one embodiment of the present invention, the original and modified documents are instantiated as iterators. In another embodiment of the present invention, the modified document is an XML file obtained from a PDA device. In another embodiment of the present invention, the modified document is an XML file obtained from a standard word processing program, such as StarWriter, Microsoft Word, or WordPerfect.

In block 810, a difference array is obtained. Each entry in the difference array contains the position of a modification to the original document in the modified document, the corresponding position of the modification in the original document, and the modification operation to be performed. The modification is either ADD, DELETE, or MODIFY. These parameters are determined in block 815.

In block 820, the modification operation determined in block 815 is executed in the original document. The algorithm iterates through the difference array to incorporate all the differences into the original document. Thus, in block 825, a determination is made as to whether more modifications exist in the difference array. If so, then in block 830 the next entry in the difference array is obtained. The algorithm then returns to block 815. If not, then the algorithm terminates.

Iterative Merge Algorithm

FIG. 9 shows an embodiment of the iterative merging of documents. Blocks 900 and 905 obtain two versions (original and modified) of a document. In block 910 a top-level analysis is performed. In a word processing document, this top-level is at a paragraph level. The paragraphs are analyzed in sequence according to a Diff algorithm. At block 915 it is determined if a difference was found. If so, a sub-level of analysis is iteratively performed at block 920. For instance, in the example, the next level of analysis is at the word level. The words are analyzed using the Diff algorithm for words. If a difference is found at block 935 then the differences array is updated in block 950. In this example, the iterative process comprises paragraph and word iterators, but in other embodiments, the difference triggers an even more detailed level of analysis, for example, the character level.

If there are no differences at block 935, it is determined if there are more words at block 940. If so, a next word is chosen at block 945 and the process repeats at block 920. When there are no more words at block 940, block 910 repeats and the iterative process continues—blocks 910 and 915 are performed if at block 915 there are no differences, it is determined if there are more paragraphs at block 955. If so, a next paragraph is chosen at block 960 and the process repeats at block 910. If however, there are no more paragraphs, a merge algorithm is performed at block 999.

Embodiment of Computer Execution Environment (Hardware)

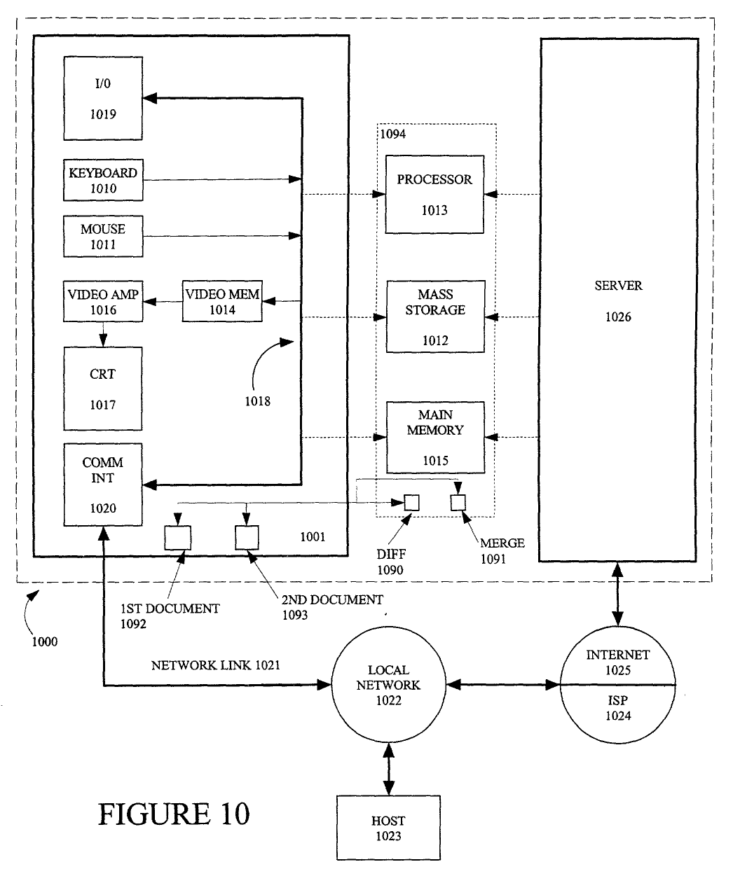

An embodiment of the invention can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU) 1013. Other suitable input devices may be used in addition to, or in place of, the mouse 1011 and keyboard 1010. I/O (input/output) unit 1019 coupled to bidirectional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, networklink 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bidirectional system bus 1018 along with keyboard 1010, mouse 1011 and processor 1013. As with processor 1013, in various computing environments, main memory 1015 and mass storage 1012, can reside wholly on server 1026 or computer 1001, or they maybe distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines maybe used instead of separate data and address lines.

In one embodiment of the invention, the processor 1013 is a microprocessor manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer maybe utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRI) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code may be executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

First and second documents 1092 and 1093 reside on client 1001, which might include a PDA or general purpose computer. Diff module 1090 and merge module 1091 may reside wholly on client 1001 or server 1026 and are shown symbolically interposed between the two in block 1094. The computer systems described above are for purposes of example only. An embodiment of the invention may be implemented in any type of computer system or programming or processing environment.

Thus, the iterative merging of documents is described in conjunction with one or more specific embodiments. The invention is defined by the claims and their full scope of equivalents.

1. A method for the merging of documents, comprising:
obtaining a first document;
obtaining a second document;
compiling a list of modifications, comprising, comparing said first and second documents at a first level of analysis; and comparing said first and second documents at a second level of analysis, if a difference exists at said first level of analysis;
updating a list of modifications; and
applying said list of modifications to said first document.

2. The method of claim 1, wherein a modification on said list of modifications comprises a record having a modification action and a modification location.

3. The method of claim 2, wherein said modification action is an addition, a deletion, or a change.

4. The method of claim 3, wherein said compiling further comprises:
selecting a modification locus when said modification action is said change;
determining a longest common subsequence of said modification locus in said first document and said second document at a second level of analysis.

5. The method of claim 4, further comprising:
obtaining a third document.

6. The method of claim 5, wherein said compiling further comprises:
determining a longest common subsequence of said first document and said third document at said first level of analysis; and
resolving one or more merge conflicts between one or more modifications necessitated by said second document and said third document.

7. The method of claim 5, wherein said third document is a markup language document.

8. The method of claim 7, wherein said markup language is XML.

9. The method of claim 1, wherein said first and second documents are markup language documents.

10. The method of claim 9, wherein said markup language is XML.

11. A computer program product comprising:
a computer usable medium having computer readable program code embodied therein configured to merge documents, said computer program product comprising:
computer readable code configured to cause a computer to obtain a first document;
computer readable code configured to cause a computer to obtain a second document;
computer readable code configured to cause a computer to compile a list of modifications, comprising, comparing said first and second documents at a first level of analysis; and comparing the said first and second documents at a second level of analysis, if a difference exists at said first level of analysis;
computer readable code configured to cause a computer to update a list of modifications; and
computer readable code configured to cause a computer to apply said list to said first document.

12. The computer program product of claim 11 wherein a modification on said list of modifications comprises a record including a modification action and a modification location.

13. The computer program product of claim 12 wherein said modification action is an addition, a deletion, or a change.

14. The computer program product of claim 13 wherein said computer readable code configured to cause a computer to compile a list of modifications further comprises:
computer readable code configured to cause a computer to select a modification locus when said modification action is said change;
computer readable code configured to cause a computer to determine a longest common subsequence in said modification locus of said first document and said second document at a second level of analysis.

15. The computer program product of claim 14, wherein said computer readable code configured to cause a computer to merge two or more documents further comprises:
computer readable code configured to cause a computer to obtain a third document.

16. The computer program product of claim 15 wherein said computer readable code configured to cause a computer to compile a list of modifications further comprises:
computer readable code configured to cause a computer to determine a longest common subsequence of said first document and said third document at said first level of analysis; and
computer readable code configured to cause a computer to resolve one or more merge conflicts between one or more modifications necessitated by said second document and said third document.

17. The computer program product of claim 15 wherein said third document is a markup language document.

18. The computer program product of claim 17, wherein said markup language is XML.

19. The computer program product of claim 11 wherein said first and second documents are markup language documents.

20. The computer program product of claim 19, wherein said markup language is XML.

21. A system for merging of documents, comprising:
a first document;
a second document;
a list of modifications means for comparing said first and second documents at a first level of analysis; means for comparing said first and second documents at a second level of analysis, if a difference exists at said first level of analysis; and means for updating and applying said list of modifications to said first document.

22. The system of claim 21, wherein a modification on said list of modifications comprises a record having a modification action and a modification location.

23. The system of claim 22, wherein said modification action is an addition, a deletion, or a change.

24. The system of claim 23, wherein said compiling further comprises:
a modification locus means for selection, when said modification action is said change;
a longest common subsequence means for determining said modification locus in said first document and said second document at a second level of analysis.

25. The system of claim 24, further comprising:
a third document.

26. The system of claim 25, further comprising:
a longest common subsequence means for determining in said first document and said third document at said first level of analysis; and
one or more merge conflicts means for resolving between one or more modifications necessitated by said second document and said third document.

27. The system of claim 25, wherein said third document is a markup language document.

28. The system of claim 27, wherein said markup language is XML.

29. The system of claim 21, wherein said first and second documents are markup language documents.

30. The system of claim 29, wherein said markup language is XML.
